(19) United States
(12) Patent Application Publication
(10) Pub. No.: US 2020/0251014 A1
(43) Pub. Date: Aug. 6, 2020

(54) METHODS AND SYSTEMS FOR LANGUAGE LEARNING THROUGH MUSIC

(71) Applicant: Panda Corner Corporation, New York, NY (US)

(72) Inventor: Juliane Jones, New York, NY (US)

(21) Appl. No.: 16/639,360

(22) PCT Filed: Aug. 16, 2018
(86) PCT No.: PCT/IB2018/056170

§ 371 Date: Feb. 14, 2020

Related U.S. Application Data
(60) Provisional application No. 62/546,406, filed on Aug. 16, 2017.

(51) Int. Cl. G09B 19/06; G09B 5/06

(52) U.S. Cl. CPC G09B 19/06; G09B 5/065

(57) ABSTRACT

A computer implemented method for generating audio language learning exercises is provided. A user's native language, target language (a language to be learned), and a user's skill level in the target language can be determined. Then, a musical language learning exercise can be automatically generated comprising words in both the user's native language and target language, based at least on the skill in the target language. The musical language learning exercise can then be played to the user.

### INCORPORATION BY REFERENCE TO ANY PRIORITY APPLICATIONS

This application claims priority to and benefit of U.S. Provisional Patent Application No. 62/546,406, titled “METHODS AND SYSTEMS FOR LANGUAGE LEARNING THROUGH MUSIC,” filed 16 Aug. 2017. Any and all applications for which a foreign or domestic priority claim is identified here or in the Application Data Sheet as filed with the present application are hereby incorporated by reference under 37 CFR 1.57.

### BACKGROUND

### Field

The subject matter disclosed herein relates generally to language learning and music pedagogy.

### Description of the Related Art

Language and music are conventionally taught in separate pedagogical methods. Despite scientific evidence that demonstrates the benefit of using music to teach language, current language pedagogies conventionally use music and song as supplementary supporting tools for language acquisition. There is currently no systematic music-language learning method with a defined music theory-language learning matrix that uses adaptive technology to customize and create new content according to a user's skill-level.

However learning language through music is highly effective, especially for children. Physiological support for language learning through music includes: 1) Humans are born musical. Newborns and infants are highly sensitive to musical information, showing a neurobiological predisposition to process music. 2) This predisposition to process music plays a critical role in early language learning, particularly in processing speech prosody (speech melody, speech rhythm), which is processed in the right auditory cortex, the same part of the brain that processes music. 3) Because of the overlapping processing of language and music, the better humans are at music, the better they will be at languages, particularly tonal languages such as Mandarin Chinese, Thai, and Vietnamese. 4) Music practice fine-tunes the human auditory system in a comprehensive fashion, strengthening neurobiological and cognitive underpinnings of both music and speech processing. True natural language learning begins with language and music processed together.

Learning language through music is a highly effective tool for vocabulary acquisition and retention. Learning language through music increases student engagement through motivation, serves as a memory aid, and serves as a stress alleviator.

Although combinations of music and language already exist, they are not easily adapted to changing skill levels such as while somebody learns a language. Further, they are not easily adapted to different languages that include not only different words and grammatical structures, but also different building-block consonants, vowels, tonal changes, and other features than increase the complexity of integrating language with music.

### SUMMARY

The methods, systems, and products described herein include various entertainment and educationally-oriented games and exercises comprising listening, rhythm, pitch, musical composition, and/or task-based exercises, which can be combined with voice recognition processing features to create needs-based adaptive learning exercises embodied in traditional forms, on computer-implemented systems, computer products, and/or on derivative products.

### Methods

The music-language acquisition methods are based on the physiological and theoretical principles that humans are born musical, and that music serves as a highly efficient mnemonic device for language acquisition.

The music-language acquisition methods can use permutations of story with music, interactive raps and singing with associated visual image and animation, rhythm exercises, pitch exercises, and task-based touch exercises that concurrently teach language and music. The exercises can use mnemonic devices to reinforce meaning, activate short-term memory, and solidify long-term memory.

It will be understood that these methods can also be used without musical accompaniment to teach language, such as where the words are spoken without a coinciding musical soundtrack. Such exercises can optionally be used in cooperation with exercises that also include musical elements such as melodic or rhythmic elements. Further, in some tonal languages, music-like variations in pitch are already inherently present.

### Systems

The music-language systems contain a plurality of resources including: vocabulary words (and their constituent syllables), word groups, phrases, and/or sentence patterns containing semantic and/or syntactic features as well as musical features that can comprise pitch, melodic and harmonic patterns, rhythm patterns, and/or audio track, and visual features that can comprise visual images, video, and/or animation.

### Adaptive Learning

The systems can be “adaptive,” meaning for example that, through techniques such as voice recognition and data analytics, the systems can listen to the user and adapt the musical and visual content according to the user's skill-level and educational needs before, during, and/or after the exercise. The systems can be able to switch between bilingual and immersion modes and create combinations of bilingual and immersion exercises to adapt to the user's skill-level. The systems can aid the user in transferring vocabulary and sentence pattern structures from short-term to long-term memory through an intelligent media generation process that creates new exercises with associated visual and/or audio resources based on relatedness.

### Display

In one embodiment, the system displays the speech-tones of tonal languages with a unique visualization of motion such as a scooter or another mode of transportation that visualizes the pitch movement. For example, the first speech-tone in Mandarin is a level tone. This can be visualized by a scooter or a cartoon character on a scooter driving on a flat road.

### Games

Easy Adaptive Song Lesson

The music-language method can include gamified exercises. In one embodiment, a computer-implemented method of language learning called an “Easy Adaptive Song Lesson” as shown in FIG. 6 comprises: 1) an adaptive story (shown in FIG. 8) with the music that will be presented later in the lesson. These stories can integrate voice recognition, so the user can vocally participate in dialogue with the characters in the story and control the plot; 2) adaptive music-language exercise (see FIG. 9) that presents the key vocabulary, phrases, and sentence patterns of the song lesson; 3) adaptive rhythm exercise(s) (see FIG. 10) that use rhythm to reinforce semantic and syntactic meaning of the vocabulary and/or phrases; 4) adaptive pitch exercise(s) (see FIGS. 11, 12, and 13) that uses pitch association to reinforce meaning of the vocabulary and/or phrases; and 5) adaptive touch exercise(s) in which the user can touch the interface, triggering audio and visual resources to engage with the vocabulary words, word groups, or phrases presented in the song lessons. Variations on this are also possible, such as changing the order of the exercises. For example, the adaptive touch exercise can optionally come third, with the adaptive rhythm exercise then being fourth, and the adaptive pitch exercise then being fifth. As another example, exercises can be replaced. For example, the adaptive pitch exercise can be removed and replaced by another exercise such as a keyboard exercise in which the user plays a keyboard in response to prompts from the system in a manner similar to vocal responses to verbal prompts.

Advanced Adaptive Song Lesson

In another embodiment, as shown in FIG. 7, a computer-implemented method of language learning through music called an “advanced adaptive song lesson” comprises: 1) adaptive story (see FIG. 8), 2) music-language exercise (see FIG. 9) and/or adaptive keyword rap and/or adaptive chorus rap and/or adaptive theme rap and/or adaptive sing-along exercise, 3) rhythm games (such as “Call and Response, Keyword Meaning Connect” described in FIG. 10), 4) pitch games (such as embodiment of the adaptive pitch game described below and shown in FIG. 11, FIG. 12, and FIG. 13), and adaptive touch games. As in the Easy Adaptive Song Lesson, discussed above, variations on the exercises and the order of the exercises are also possible.

Adaptive Story

An adaptive story can present the basic music patterns (melodic and rhythmic patterns) from the song lesson and can run in bilingual or immersion modes. The story can integrate voice recognition, such that the user can vocally participate in dialogue with the characters in the story to advance the story and to control the plot by touching and speaking. Through voice recognition, the cartoon character can listen, respond to the user, translate, and/or sing in response to and with the user.

Adaptive Imitate Music-Language Exercise

The “Adaptive Imitate Music-language Exercise” can guide the user from text comprehension and articulation to singing a bilingual or immersion song in a progression through which they gain a level of meaning at each stage. The vocabulary and pitch in the multichannel audio tracks can adjust before, during, and after the exercise according to the user's skill-level. As shown in FIG. 9, the progression through the exercise is: 1) Vocabulary (See FIG. 9, 901 and 902) which can be presented in bilingual alternate form in which translation meaning is presented with visual and auditory references and story association or in immersion form, without the translation reference to a source language; 2) pitch match (See FIG. 9, 903) presented in call and response form in a series where a word is sung on a pitch and the user repeats the word. One or more words can be presented creating a series. In one embodiment of the pitch match section, the user focuses on pitch association in immersion form (only in the target language), losing the translation reference, but maintaining the auditory and visual references and story context; 3) speech-tone contour practice (See FIG. 9, 904), in which the user focuses on learning speech-tones by practicing to speak in call and response form in a series, losing the translation reference, but maintaining the auditory and visual references and story context; 4) Call and response singing (See FIGS. 9, 905); and 5) Sing-along (See FIG. 9, 906). In other embodiments, the audio track can be single channel. Other embodiments can offer permutations in which the exercises only adjust the vocabulary, only adjust the pitch, and only make adjustments before, during, and/or after the exercise.

Adaptive Rhythm Game

The methods present several adaptive rhythm games. One embodiment is called “Call and Response, Keyword Meaning Connect” in which the user hears a vocabulary word, word group, or phrase in the target language followed by a cartoon character playing a rhythm, or an off-screen rhythm being played. The user then repeats the rhythm with their tap button on the user's device 109 or a smart drum device that syncs with the user's device, which serves as a controller for the animation of the object that is visualizing the vocab word. This cycle of 1) vocab word, 2) rhythm call, and 3) user rhythm response can occur in various permutations, all solidifying the connection between the word meaning and the rhythm. Other embodiments can include permutations of the following: 1) vocab word or phrase, 2) vocab response, 3) rhythm call, and 4) rhythm response. In other embodiments, the rhythm can reflect the syllable-rhythm or melody-text rhythm and can be concurrently played while the vocab word is spoken or following the vocab word. In all forms, these exercises use rhythm to reinforce meaning of keywords and phrases. The user physically and mentally engages with the object through rhythm that can activate animation, solidifying word-meaning and word order in short phrases or sentences.

Adaptive Pitch Game

The methods present several adaptive pitch games. In one embodiment of an adaptive pitch game, the user associates a single word or short phrase of vocabulary with pitch, which can be accompanied by piano visualization. The pitch serves as a mnemonic for word-meaning. In another embodiment of an adaptive pitch game, the user alternates speech-tone call and response and song pattern call and response presented in a musical phrase. In this exercise the user is activating the musical and language processing areas of the brain, strengthening the cognitive underpinnings of the auditory system in order to height pitch processing ability.

Products

The methods and systems can be presented on a wide variety of different systems and products including computer products and computer readable storage media.

In one embodiment, smart instruments such as a smart drum or smart ukulele can sync with the adaptive song lessons to reinforce language learning through rhythm, pitch, and repertoire. In another embodiment, the system can sync with smart toys.

In one embodiment, a computer implemented method for generating audio language learning exercises is provided. A user's native language, target language (a language to be learned), and a user's skill level in the target language can be determined. Then, a musical language learning exercise can be automatically generated comprising words in both the user's native language and target language, based at least on the skill in the target language. The musical language learning exercise can then be played to the user. A non-transitory computer-readable medium storing instructions that, when executed by one or more processors of a computing system, can cause the computing system to perform this method, or a computer program product doing the same, can also be provided.

In a further embodiment, a computer implemented method for teaching tonal languages can be provided. A word can be displayed to a user, the word having a correct pronunciation that requires a specific change in pitch. Further, a sound of the word can be outputted to the user. An interactive element can be provided to the user allowing the user to adjust a speed of pronunciation of the word during the outputting of the sound to the user. A non-transitory computer-readable medium storing instructions that, when executed by one or more processors of a computing system, can cause the computing system to perform this method, or a computer program product doing the same, can also be provided.

In a further embodiment, a computer implemented method for teaching tonal languages can be provided. A word can be displayed to a user, the word having a correct pronunciation that requires a specific change in pitch. A graphical representation of the specific change in pitch can also be displayed to the user. A sound of the user saying the word can be received, and a graphical representation of a change in pitch made by the user while saying the word can also be displayed such that the change in pitch made by the user and the change in pitch associated with the correct pronunciation can be compared. A non-transitory computer-readable medium storing instructions that, when executed by one or more processors of a computing system, can cause the computing system to perform this method, or a computer program product doing the same, can also be provided.

Various components of the systems and methods are described in further detail below.

### BRIEF DESCRIPTION OF THE DRAWINGS

Further objects, features, and advantages will become apparent from the following detailed description taken in conjunction with the accompanying figures showing illustrative embodiments, in which:

FIG. 1 shows the components of an example embodiment of a music and language learning system.

FIG. 2 is a flowchart depicting an adaptive audio algorithm that can occur in an exercise or game.

FIG. 3 is a flowchart depicting an algorithm for adaptive language modes.

FIG. 4 is a flowchart depicting an algorithm for intelligent game or exercise generation.

FIG. 5 is a screenshot of a Graphical User Interface (GUI) showing an example embodiment of a transportation visualization of speech-tone contours.

FIGS. 5A-5E depict various visualization of speech-tone contours from Mandarin Chinese.

FIG. 6 is a flowchart of the elements of an Easy Adaptive Song Lesson.

FIG. 7 is a flowchart of the elements of an Advanced Adaptive Song Lesson.

FIG. 8 is a flowchart of an algorithm for presenting an Adaptive Story.

FIG. 9 shows screenshots displaying a GUI of an Adaptive Imitate Music-language exercise.

FIG. 9A is a flowchart depicting an algorithm for generating a song for language learning.

FIG. 9B is a flowchart depicting an algorithm for overlaying words and music.

FIG. 9C is sheet music of a section of a song generated by the algorithms in FIGS. 9A and 9B, indicating the song in multiple languages.

FIG. 9D depicts audio files of words that can be used with the algorithms in FIGS. 9A and 9B.

FIG. 9E depicts audio files including music, words in two languages, and the combination of these files to create a song for language learning.

FIG. 10 is a screenshot of a GUI of a Rhythm-language acquisition game, titled “Call and Response Keyword Meaning Connect.”

FIG. 11 is a screenshot of a GUI of a Pitch-language acquisition game that teaches vocabulary through pitch association.

FIG. 12 is screenshots of a Pitch-language game GUI that teaches vocabulary through pitch association.

FIG. 13 is a screenshot of a GUI of a Pitch-language game that connects word meaning and pitch association within the context of a musical scale.

FIG. 14 is an example of a graphical user interface (GUI) displaying a dashboard of a music-language game for a learner

FIG. 15 is an example song selection interface.

FIG. 16 shows one embodiment of progress during language acquisition games.

FIG. 17 is a rhythm skills and language skills graph for one embodiment of a music-language curriculum.

FIG. 18 is a pitch skills and language skills graph for one embodiment of a music-language curriculum.

FIG. 19 is a flowchart depicting an algorithm for real time and periodic adaptation.

FIG. 20 is a flowchart depicting an algorithm for internal exercise adaptation.

### DETAILED DESCRIPTION

Reference will now be made to the example embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are considered within the scope of the invention. For example, embodiments using an exercise could alternatively use a game, and vice versa. More generally, different kinds of activities can use similar techniques used in the examples described herein.

### System

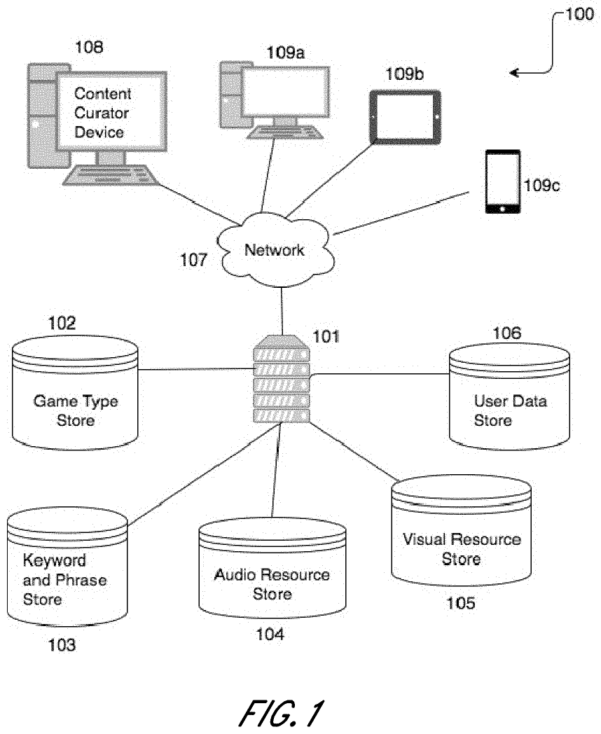

FIG. 1 shows the components of an example embodiment of a music and language learning system 100.

The music and language learning system 100 of FIG. 1 comprises a language learner server 101, an activity type store 102 storing various types of activities that can be provided by the system, a keyword and phrase store 103 storing sets of words and characteristics of those words that can be used in the activities, an audio resource store 104 storing audio files that can be used to generate words, phrases, or music that can be used in the activities, a visual resource store 105 including images that can be used in the activities, a user data store 106 storing information about various users such as their skill level and performance on previous activities, a network 107, a content curator device 108, and language learner's computing device(s) 109a, 109b, or 109c. As shown in this example embodiment, a language learner's computing device 109 can be a language learner's computer 109a, a language learner's tablet 109b, or a language learner's smart phone device 109c. It will be understood that the language-learner can be a user of the system 100. However, the user of the system 100 can also be a parent of the learner, or an instructor of the learner.

In the example embodiment of the language learning system 100 in FIG. 1, the music and language learner server 101 is shown as a single device. However, the music and language learner server 101 can also comprise multiple computing devices. In such distributed-computing systems, where a music and language learner server 101 comprises a plurality of computing devices, each of the computing devices can comprise a processor, and each of these processors can execute music-language learning modules that are hosted on any of the plurality of computing devices and stored on computer-readable media, as further described herein.

In an exponential effect of the language learning system 100, one or more data stores with additional database columns can be added to each store. Adding 1 database column for 1 data store yields a (1*1)*(N data stores) game creation space. When all visual and audio resources are tagged with metadata and a “relatedness” score column is added for both data stores, the game creation space would become=(2*2)*(N data stores). This growth factor closely matches an exponential function of g(y)=y\hat{ }x, where y is the original, fixed number of data stores. Through the exponential effect embodiment, the game creation space can grow without adding extra resources to each data store.

### Adaptive Functions

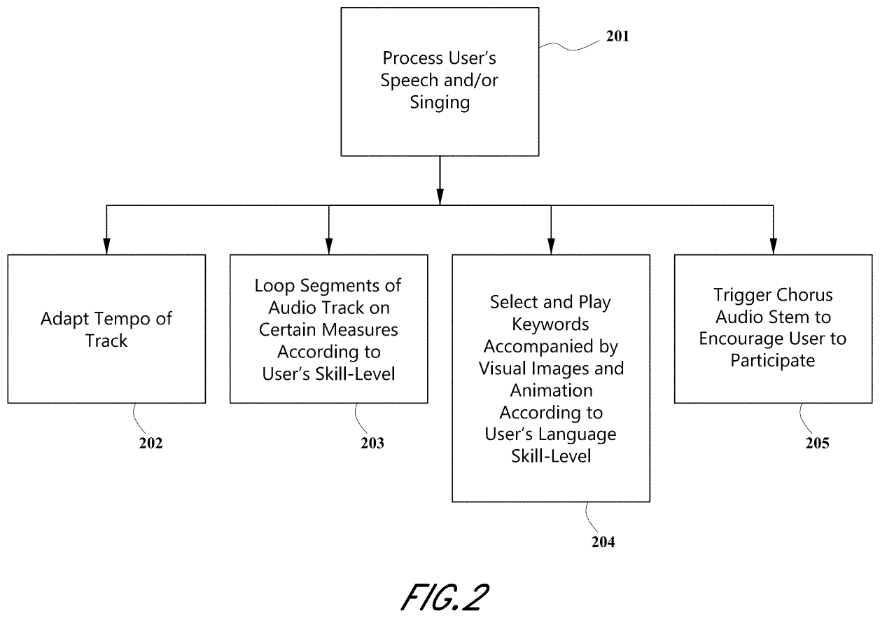

FIG. 2 shows an algorithm for an adaptive audio exercise 200 that can occur in an exercise or game and can be performed by a module run on a processor in the system 100 such as the language learner's computing device 109 or the language learner server 101, or on a combination of multiple parts of the system 100. As an example, the exercise or game can include a sing-along style activity where the device plays a song to a user and prompts the user to sing particular words at particular times to match the pitch and rhythm of the song. As another example, the exercise or game can include a call-and-response style activity where the device outputs one or words and prompts the user to repeat the words or recite other words responsive to the device's audio or visual output. Other exercises and games are also possible.

The adaptive audio function comprises listening to the user (for example using a microphone on the device 109), and processing the user's speech and/or singing through, for example, voice recognition (using techniques such as those described in U.S. Pat. Nos. 5,068,900; 9,009,033; and 9,536,521, which are incorporated by reference herein in their entirety) and pitch-recognizing software (such as that described in U.S. Pat. No. 5,973,252, which is incorporated by reference in its entirety herein), and then adapting the musical and visual content before, during, and/or after the activity based on the user's performance and skill-level. The following steps can occur in any order based on the user's performance during an activity. In step 201, the adaptive audio function processes the user's speech and/or singing. Processing the user's speech and/or singing can include determining words stated by the user and determining if the words are pronounced correctly (such as determining if a tonal change in the word is correct). When processing the user's speech, the adaptive audio function can also determine if a user is having trouble keeping up with the pace of the exercise such that, for example, the user recites words late relative to the rhythm of a song or appears to be missing words entirely. The adaptive audio function can use this information to determine that the audio track is too fast for the user, in step 202, and can then slow the audio track (while preserving the pitch by adjusting the audio file for the change in speed, as described for example in U.S. Pat. No. 5,973,252, which is incorporated by reference in its entirety herein, and alternatively in software called Melodyne and provided by Celemony). Similarly, using the information from Step 201, if a user is determined to have missed a keyword or pitch, in step 203, the function can loop back on a measure so that portion of the activity is repeated. Further, if a user is determined to have difficulty with certain keywords or musical skills, in step 204, the function can adjust the words and music, inserting keywords, pitch, or rhythm resources according to the user's skill-level. If the user is determined to not be participating, in step 205, the function can activate a chorus sound including the sound of others speaking or singing to encourage the user to participate.

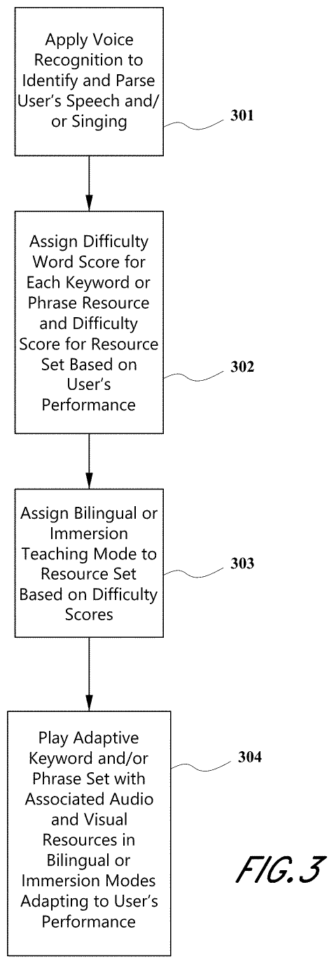

FIG. 3 shows an algorithm for adaptive language modes through which the system 100 (such as a language learner's computing device 109 or the language learner server 101, or a combination of multiple parts of the system 100) can generate a keyword or phrase set in bilingual or immersion modes. The generated keywords and phrases can be used to determine the words and phrases that will be included in the activities described herein. In step 301, the system identifies and parses the user's speech and/or singing in one or more previous activities, for example using voice recognition software. This information can be used to determine a skill-level of the user, for example by determining if they are reciting the correct word, with correct pronunciation, at an appropriate rhythm and pitch. In step 302 a difficulty score is assigned to individual words, word groups, and word sets. Based on the difficulty scores, in step 303 bilingual, immersion modes, or a combination of these modes are assigned to the words, word groups, or word sets. In step 304, the words or word groups are played in combinations of bilingual or immersion modes according to the skill-level and personalized educational needs of the user.

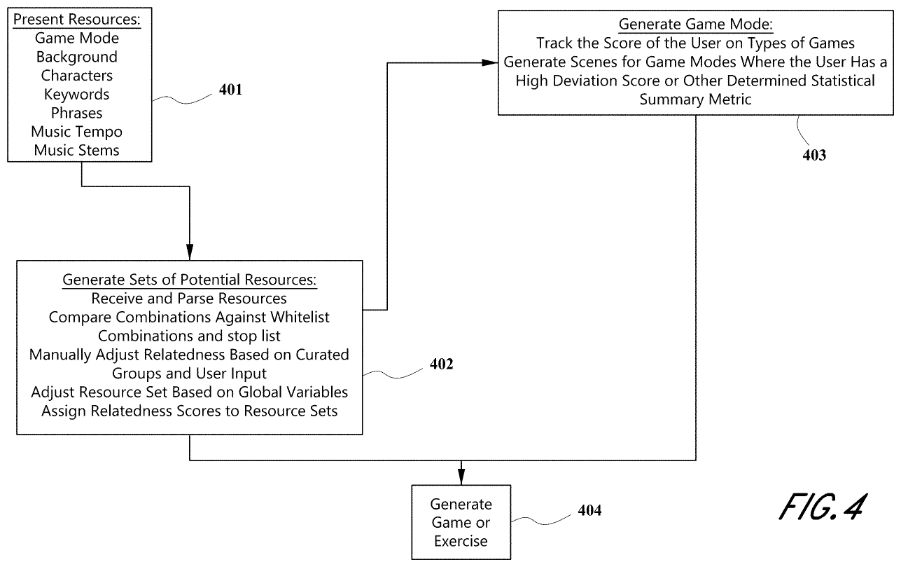

FIG. 4 is an algorithm for a method embodiment of intelligent game or exercise generation that can use the words and phrases determined from the previously described process in FIG. 3. In step 401, a finite number of resources are provided during a scene construction process. The resources comprise but are not limited to Game Modes (such as a sing-along or call-and-response game), Background (such as in a city, playground, farm, or other location to be depicted visually in the background), Characters (such as humans, animals, or other characters), Keywords to be used, Phrases to be used (that can include the keywords), Music tempo, Music stems (a stem is a discrete or grouped collection of audio sources, examples can include: a drum stem, a bassline stem, a vocal stem, which can be short pieces of audio stored as audio files). In step 402, discrete sets of potential resources are generated in which the system receives and parses the resources from step 401. For example, the system can compare potential combinations against a whitelist of highly related resource combinations (such as a combination of a farm background, with farm animal characters, and words such as “fence”, “cow”, and “milk”, and a stop list of combinations with low relatedness scores (such as a combination of a city background with farm animal characters). The relatedness scores can indicate how related different resources are, such as a farm animal being highly related to farm backgrounds, less related to outdoor backgrounds, and minimally related to city and outer-space backgrounds. The resource set can be adjusted manually, through user input, and/or based on global variables, and a relatedness score is then assigned to the resource set. In step 403 the system can use information from step 402 to generate a specific exercise, particularly chosen for the user. For example, the system can use the user's performance scores in previous activities to generate educationally appropriate training modes. In step 404 a personalized, educationally appropriate game or exercise (or another type of activity) is presented to the user.

### Display

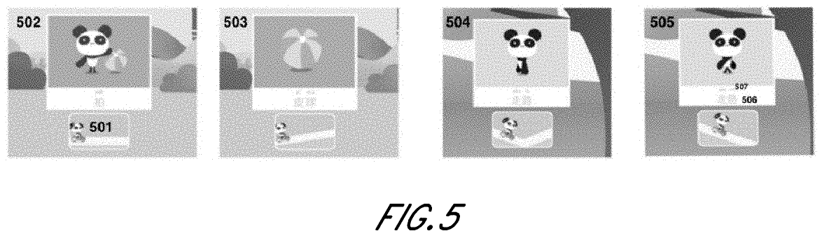

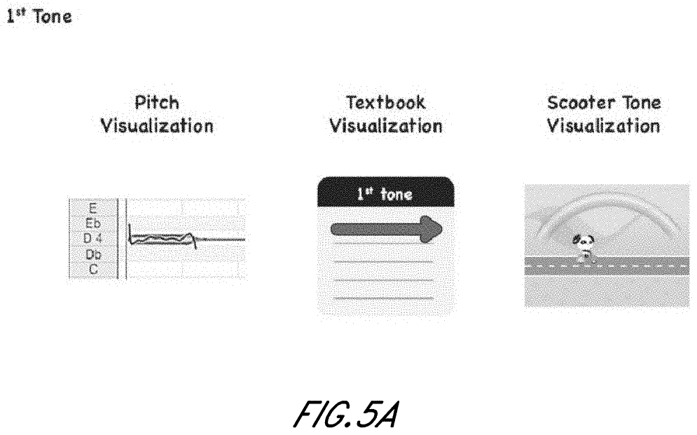

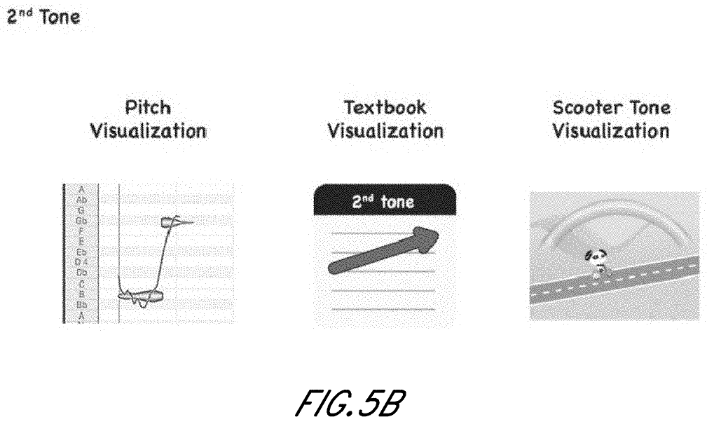

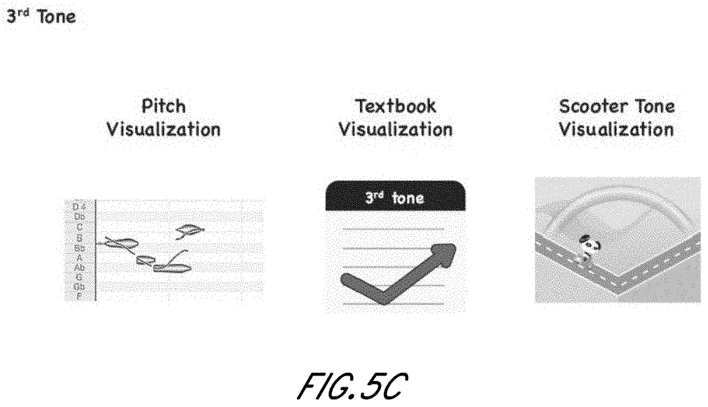

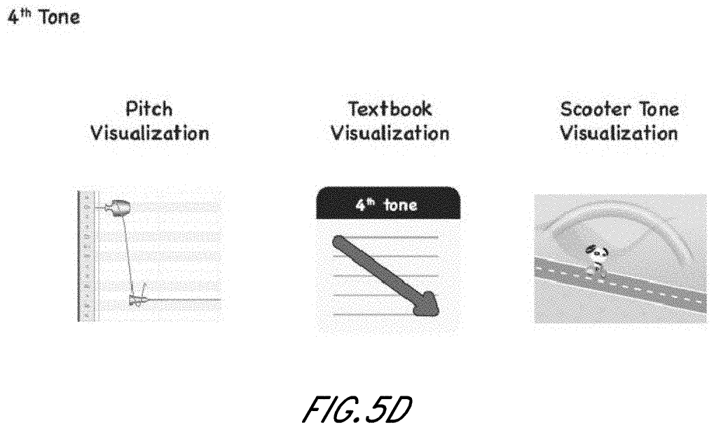

FIG. 5 is a screenshot of a GUI 500 showing an example of a transportation visualization of speech-tones particularly for tonal languages, which can be used in activities generated by the system 100 to teach words and correct pronunciation. From left to right the screenshots show the speech-tone visualization with a scooter 501 that will drive forward, visualizing a speech-tone contour of first tone 502, second tone 503, third tone 504, and fourth tone 505 in Mandarin Chinese. The scooter 501 can be replaced with any other movement or graphical representation of the change in pitch, such as another mode of transportation visualization such as a car, truck, plane, or a cartoon or person walking, or something as simple as an icon moving along a path. The images can show the Chinese character 506 and romanization (pinyin) 507 of the word. The images can be accompanied by other resources including text, audio pronunciation of the word, and musical background. The movement visualization can also be applied to languages other than Mandarin Chinese.

More generally, the system 100 can display a word to the user that has a specific pitch profile (such as a pitch that stays even, rises, falls, rises and then falls, falls and then rises, and other profiles). As shown in FIG. 5, and more clearly shown in FIGS. 5A-5E (showing some of the basic tones of Mandarin Chinese), a set of different tones can each have different pitch profiles. In FIG. 5A, a first tone from Mandarin Chinese is shown with a substantially even and unchanging pitch. The Pitch Visualization indicates the sound of a user's voice when correctly saying a word having the first tone. Although the Pitch Visualization indicates that the pitch corresponds to the note D, this specific note is not necessary and a different starting pitch would also be correct. For the first tone, as indicated in the Textbook Visualization and the Scooter Tone Visualization, what is important is that the pitch stays substantially even.

To further demonstrate this tonal pattern to a user, the system 100 can also output the sound of the word to the user (including a possible change in pitch), and allow the user to interactively engage with that sound. For example, the system 100 can allow a user to adjust the speed of pronunciation of the word while it is outputted to the user. The word can be stored as an audio file, such that the speed of pronunciation can be determined by a speed at which the audio file is played. The user can cause the word to be recited slower or faster through the speed of playing the audio file. This can be done, for example, by the user dragging an icon across the screen (such as with a touchscreen or a mouse device) such that the user directly controls the progress of the pronunciation of the word. In one embodiment, the user can drag the scooters shown in FIG. 5 across the track, such that the word is recited (with the appropriate pitch) as the scooter moves across the track. The speed of the word can also be adjusted by a user adjusting a speed such as by choosing between “fast” and “slow”. Notably, adjusting the speed of the word can be implemented by adjusting the speed at which an audio file is played. Because adjusting the speed of an audio file being played can alter the pitch and timbre, pitch and timbre correcting software such as that described in U.S. Pat. No. 5,973,252 (incorporated by reference herein, in its entirety) can be used to preserve an appropriate sound. These audio files can be provided by the system 100, and can also be recorded by a user (for example, an instructor or parent of the learner-user).

The system 100 can also teach a user to correctly say the word (with the correct pitch profile) and provide feedback to the user related to their pronunciation. For example, the system 100 can include an audio sensor such as a microphone on the user's device 109. The system 100 can thus receive a sound made by the user attempting to say a word, and can detect if the pitch is correct, and indicate to the user if the pitch is incorrect. For example, the pitch made by the user while saying the word can be shown on a chart alongside the correct pitch, such as by overlaying the Pitch Visualization and the Textbook Visualization shown in FIGS. 5A-5E, so that the two pitch profiles can be compared. If the pitch made by the user differs from a correct pitch profile by more than a threshold, the user can be alerted to this, and the result can also be recorded by the system. If the user uses the wrong pitch profile, the system 100 can repeat the activity immediately, at another time in the future, or can use this information to indicate a user's skill level when generating future activities. In some embodiments, the user's voice can be used to adjust a path of the transportation visualizations shown in FIG. 5.

These concepts can be better understood by reviewing other tones from Mandarin Chinese, as shown in FIGS. 5B-5D. FIG. 5B depicts the second tone (also referred to as a rising tone), which includes an increase in pitch. As shown, the increase in pitch can move from the note B up to the note G-flat, but other starting pitches, ending pitches, and changes in pitch can also be considered correct. For example, an increase in pitch corresponding to at least 5 semitones and/or less than 7 semitones on a 12-tone scale can be considered correct.

FIG. 5C depicts the third tone, which includes a decrease in pitch, followed by an increase in pitch. Again, although a specific set of pitches is shown in the Pitch Visualization, other pitches can also be considered correct. For example, a decrease of at least 2 semitones followed by an increase of at least 3 semitones can be considered correct.

FIG. 5D depicts the fourth tone (also referred to as a departing tone), which includes a decrease in pitch comparable to the increase in pitch in the second tone. A decrease in pitch corresponding to at least 8 semitones on a 12-tone scale can be considered a correct fourth tone.

Variations are also possible. For example, multi-syllable words can be separated into their individual syllables. Each syllable can be recorded as a separate audio file, such that words can then be automatically generated by combining the component single syllables. Similarly, visualizations of the pitch (including a change in pitch) of the multi-syllable word can also be automatically generated by combining the component single syllables. For example, if the sound of a two syllable word will be outputted by the system 100, then the audio of the first syllable can be played first, and then the audio of the second syllable can be played. The transition between syllables can be seamless, such as by playing the audio files together with no gap and similarly displaying the pitch profiles together with no gap. However, the system 100 can also optionally provide a break in between the syllables to emphasize the change in tones in each syllable. Thus, for multi-syllable words the displayed tone profile can optionally show the profile of the first syllable initially, and that profile can be replaced by the profile of the second syllable after the first syllable has been completed. Alternatively, the profile of both syllables can be shown at the same time, creating an extended tonal profile shown to the user at one time.

In a more specific example, in Mandarin Chinese certain tones can change depending on the tone that follows them. For example, as shown in FIG. 5E, if the third tone is followed by another third tone, the initial third tone is changed to a second tone. Thus, in a two syllable word with two third tones, the initial syllable becomes a second tone. To account for this, the system 100 can adjust the graphical display and audio output of a syllable according to the following syllable to account for this change in tone profile. The system 100 can also potentially include two-syllable audio files and graphical representations of pitch that correspond to these situations.

The various audio files and graphical representations can be stored, for example, on the user/learner devices 109, the audio resource store 104, the video resource store 105, or other parts of the system 100. Similarly the user's performance on these activities can be stored on the user devices 109, the user data store 106, or other parts of the system 100. Even further, the adaptive methods described herein can similarly be used with these activities. These activities can also be combined with other activities, such as the adaptive song lessons discussed below. As another example, these speech tone exercises can be combined with an explanation of the meaning of the word being recited.

### Song Lesson Designs

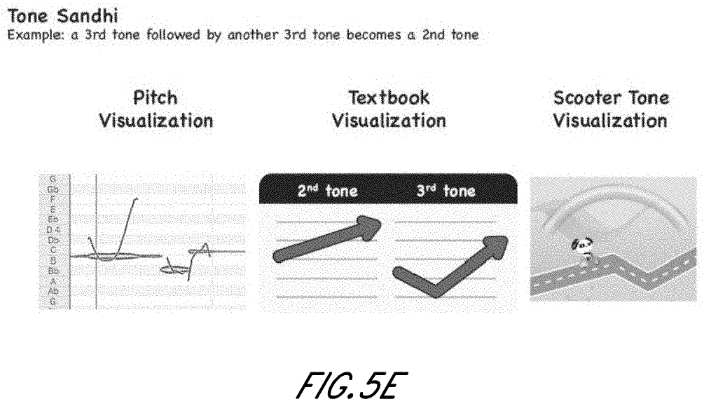

FIG. 6 shows a flowchart of the activities in an “Easy Adaptive Song Lesson.” From left to right the sections comprise: Adaptive Story 601, Adaptive Imitate Music-language Exercise 602a or Adaptive Sing-along exercise (defined below) 602b, Adaptive Rhythm 603 game or exercise, Adaptive Pitch 604 game or exercise, and Adaptive Touch Game 605. In an Adaptive Sing-along exercise 602b, the user is presented with new vocabulary words or phrases in the context of song verses and choruses in call-and-response form and sing-along form. The exercise can loop or slowdown in tempo depending on the user's performance. In an Easy Adaptive Song Lesson, through voice recognition software, the system creates customized content before, during, and/or after an exercise or game according to the user's skill level and educational needs. An “Easy Adaptive Song Lesson” is normally presented in this order, but the steps can occur in a different order and/or can be repeated and varied according to the user's educational skill level and needs.

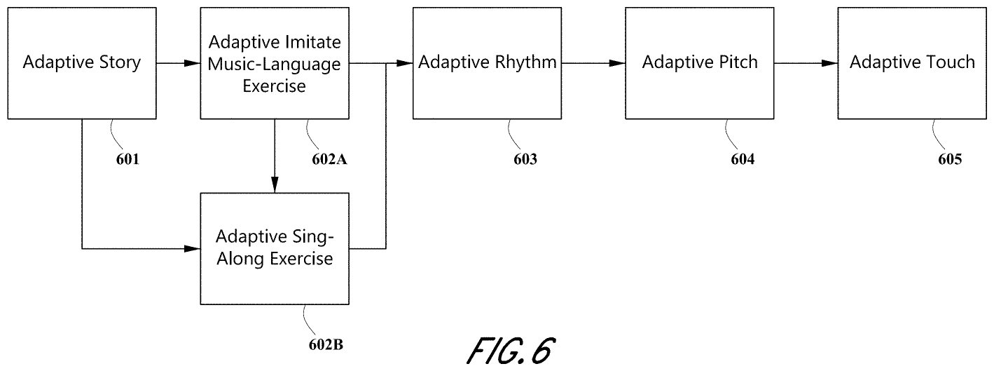

FIG. 7 shows a flowchart of an “Advanced Adaptive Song Lesson.” The advanced adaptive song lesson allows the user to make more decisions influencing the outcome of the plot and music than the “Easy Adaptive Song lesson.”

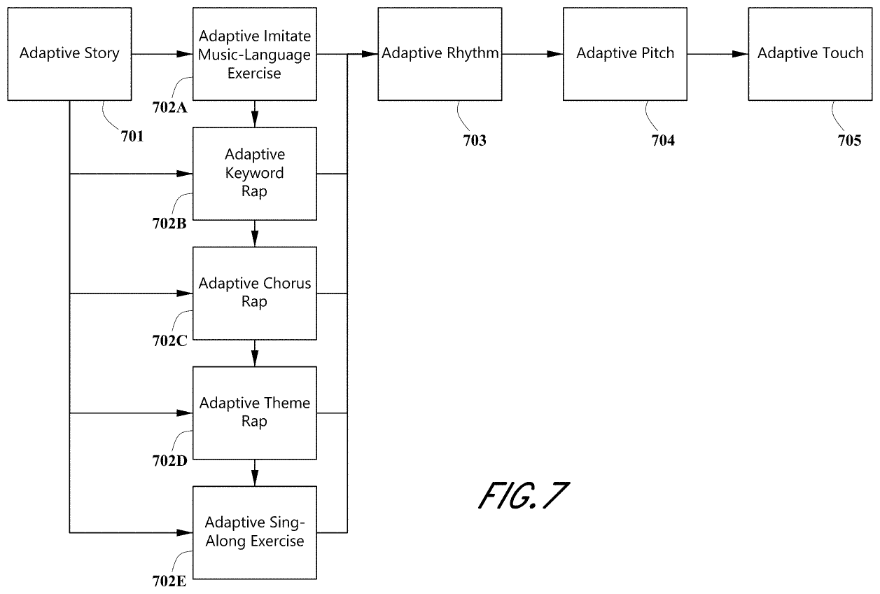

In Adaptive Story 701 (as described further below and depicted in FIG. 8) the user can communicate with the cartoon character in a dialogue that influences the outcome of the plot. The user can touch, speak, and/or sing, and the user's words can be recognized by the system through voice recognition software. The cartoon character can respond with speech and/or animation. The scene creation of the story will adapt according to the user's responses.

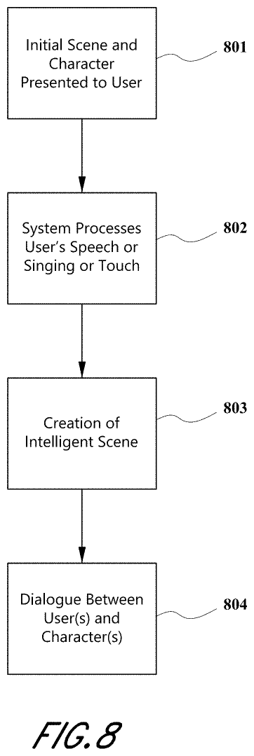

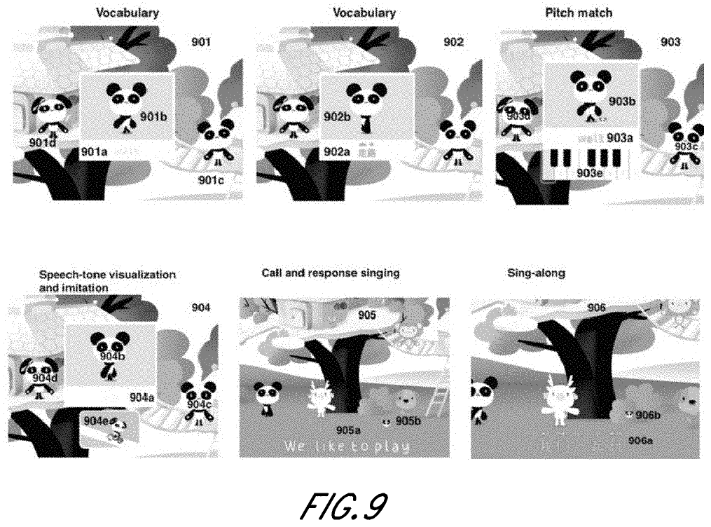

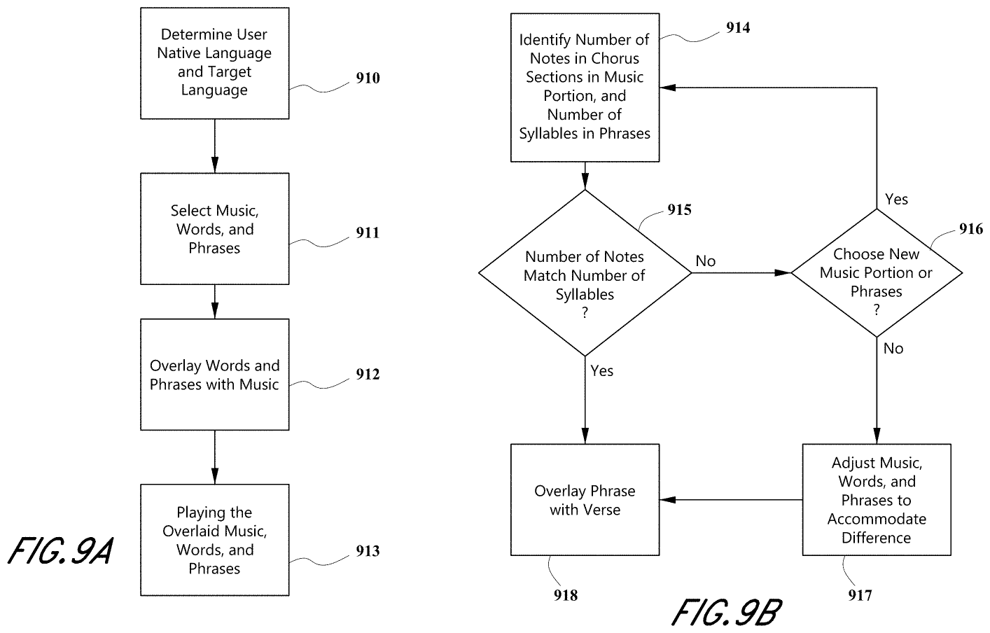

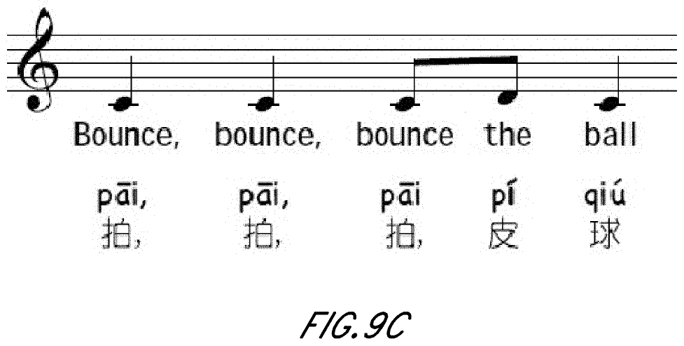

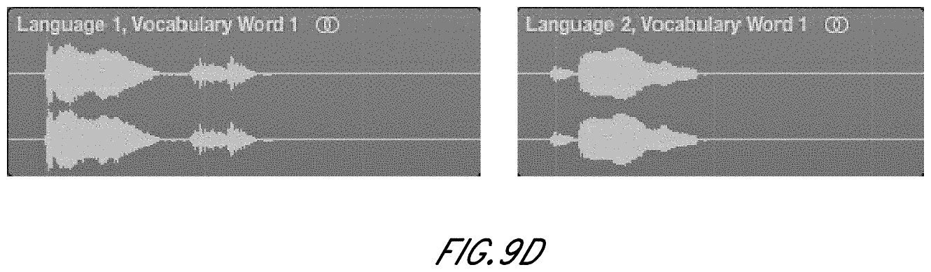

In the step 702, users learn vocabulary and sentence patterns in exercises with custom-designed content which is adapted before, during, and/or after the exercise takes place. Users can be presented with multiple exercises or a single exercise in 702. Exercises in 702 consist of an “Adaptive Imitate Music-language Exercise” 702a (as defined in FIG. 9), “Adaptive Keyword Rap” 702b, “Adaptive Chorus Rap” 702c, “Adaptive Theme Rap” 702d, “Adaptive Sing-along Exercise” 702e (as defined in FIG. 6). An “Adaptive Keyword Rap” 702b presents the keywords, word groups, and or phrases in a call and response rap simultaneously displaying visualization of word meaning and speech-tone contour. An “Adaptive Chorus Rap” 702C consists of the phrases of a song chorus presented in spoken and/or spoken call and response form accompanied by an audio backtrack and visualization of the word and/or phrase meaning. An “Adaptive Theme Rap” 702d presents the keywords based on a song lesson theme, word groups, and or phrases in a call and response rap simultaneously displaying visualization of word meaning and speech-tone contour.

In step 703, the rhythm game or exercise solidifies the language, sentence structure, and/or vocabulary words learned in the song lesson through mnemonic rhythm activities. The rhythms can adapt to the user's skill level. For example a young child would only hear quarter and eighth notes, whereas a more advanced user would hear rests and syncopated patterns. In step 704, the user hears associated pitches and pitch patterns with the keywords, word groups, and sentence patterns presented in the song lesson. The pitch exercise adapts to the user's skill level, customizing the pitch patterns and words. In step 705 a user plays an adaptive touch game or exercise that is either free play or an assessment of the content presented in the song lesson. An “Advanced Adaptive Song Lesson” is normally presented in this order, but the steps can occur in a different order and/or can be repeated and varied according to the user's educational needs.

### Story

FIG. 8 shows an algorithm for providing an Adaptive Story that can include music, can run in bilingual or immersion modes, and can utilize voice recognition processing features. In step 801, the initial scene design and character(s) are presented to the user along with the music (specifically the melodic and rhythm patterns) that are presented later in musical portions of the activity. In step 801, the user is encouraged to either speak, sing, or touch the device through an auditory or visual cue. In step 802, the system processes the user's speech or singing, or responds to the user's touch, generating possibilities for intelligent scene creation customized to the user's language and music ability. In 803, the system creates a multimedia scene based on the user's response. Multimedia assets including background, character, audio, and visual resources are displayed based on user's interaction with the story. In step 804, within the intelligently designed scene, using voice recognition processing, one or more cartoon characters responds by speaking or moving or a combination of speaking and moving, engaging the user in dialogue. The character(s) engaged in dialogue with the user can draw from user data store to speak in words and word-groups that the user has learned.

### Adaptive Imitate Music-Language Exercise

FIG. 9 shows screenshots of a GUI 900 of an Adaptive Imitate Music-Language exercise. The sections comprise Vocabulary 901 and 902 (showing the vocabulary word “walk”) which can be presented in bilingual alternate form with the source language 901a followed by the target language 902a or in immersion mode displayed in only the target language 901a with the visualization of word-meaning 902b. Vocabulary text 902a can be displayed with romanization and Chinese characters. The cartoon characters 901c and 901d can speak the vocabulary words. In the next step, Pitch Match 903, the cartoon character 903c and 903d or app sings the vocabulary word on a pitch or pitch pattern, and the user responds by imitating, singing the vocabulary word on the pitch or pitch pattern. The word text 903a can be visualized and the pitches can be visualized by a piano 903e that can be blank or can have numbers indicating scale degree, note names, or solfege written on the piano notes. Notation is customized based on the user's education needs and regional customs. Pitch can also be visualized on a staff or other instrument tablatures, such as guitar tablature. In the next figure, Speech-tone visualization and Imitation 904 the cartoon character(s) or app 904c and 904d speak the vocabulary word or word group while the scooter-tone 904e shows the visualization of the speech-tone contour (possibly using methods similar to those described in connection with FIGS. 5 and 5A-5E). The word text is visualized in 904a and the meaning of the word is simultaneously visualized 904b. In the next figure Call and Response Singing 905, the pitches or pitch patterns from 903 are expanded into musical phrases presented in call and response singing form with the text that uses vocabulary from 902. In the final figure, Sing-along 906 the user can sing the song chorus expressing the pitch patterns and vocabulary learned in the previous steps 902, 903, 904, 905. The song lyrics 906a can be displayed and the panda head 906b can play showing the user when to sing. 902, 903, 904, and 905 do not have to be presented in this particular order and can be re-ordered based on the user's skill-level and personalized learning needs. When presented in this order, 902 through 905 guides the user from text to singing, at each step gaining levels of language and musical meaning.

Notably, the musical language learning exercise can be generated automatically by the system 100 from a variety of resources, as discussed above and shown for example in FIG. 4. Among the elements that can be included in this exercise (and other exercises generated by the system 100) are words and music. Once a learner's native language and target language (the language to be learned) have been determined, the exercise can be generated.

FIG. 9A depicts a process for generating a musical language learning exercise. At an initial step 910, the user's (for example, a learner's) native language and target language can be identified. Additional information can also be identified, such as the user's ability level in each language, the user's musical ability level, subjects that the user is known to like or dislike, words and phrases that the user has not yet learned, and other features. The information can be retrieved from the user data store 106 or other sources and then be used to select a music portion and words and phrases that can be overlaid with each other at step 911. The music portion can be selected according to, for example, a user's musical ability and preferences. The music portion can also include repeatable features, such as one or more bars of music that can be repeated while maintaining a consistent melody.

The words and phrases that can be overlaid with the music portion can be prerecorded audio files in either or both of the user's native language and target language. As discussed above, with respect to FIGS. 5 and 5A-5E, they can be prerecorded as individual syllables, pairs of syllables, complete words, or even complete phrases. Notably, prerecorded audio files can be modularly combined to form more complex words and phrases. For example, syllables can be modularly combined to form pairs of syllables and complete words, and words can be modularly combined to form phrases.

Storing the words and phrases as smaller modular components can provide further advantages. When the words and phrases are combined with a music portion, it can be desirable to adjust the rhythm and pitch of the words and phrases to match the melody of the music to create a song. For example, each syllable's pitch can be adjusted to match the pitch of a corresponding note in the music portion. Syllables' durations can also be adjusted to match the lengths of corresponding notes in the music portion. Even further, for syllables that include a change in pitch, the beginning and ending pitches can be adjusted to match two consecutive notes corresponding to the syllables in the music portion. For example, for a second tone in Mandarin Chinese, an initial pitch can be adjusted to match a first note and an ending pitch can be adjusted to match a second, higher note following the first note. Similarly, for a fourth tone in Mandarin Chinese, an initial pitch can be adjusted to match a second, lower note following the first note.

As shown in FIG. 9A, once a music portion, words, and phrases have been chosen, they can be overlaid together in step 912 such that the words are contemporaneous with associated notes to melodically integrate with the music portion. This audio can then be played to a user to provide the musical language learning exercise in step 913.

FIG. 9B depicts a more detailed process for selecting music, words, and phrases, and overlaying that content together. Generally, the musical language learning exercise can involve a song, which includes words corresponding to notes in a melody. For a song, it is often preferable for each syllable in the words and phrases to correspond to a separate note, although it can also be acceptable to spread a syllable over multiple notes or to split a note into multiple syllables (such as by splitting a single whole note for one syllable into two half notes at the same pitch for two syllables). It can also be preferable to have a phrase in a song match with a particular portion of the melody, such as in a verse-chorus structure with different themes alternating. Thus, in a first step 914 the number of notes in chorus sections (or similarly, in verse sections) in a music portion, and the number of syllables in phrases can be identified.

In the following step 915, the number of notes and syllables can be compared. If the numbers match, then the system 100 can assign each syllable to a corresponding note, adjust the duration and pitch of each syllable accordingly, and overlay the language and music in step 918. If the number of notes and syllables do not match then the system 100 can optionally choose a new music portion or a new set of phrases (restarting the process), or it can make adjustments to the music, words, or phrases to accommodate the difference at step 916. It can be preferable to choose a new music portion or phrases if the difference is not easily adjusted-for or there are likely to be other combinations that match better. For example, if the words used all have one syllable, and there is one extra unassigned note, then a two-syllable word (such as “balloons”) can substitute for a one-syllable word (such as “clouds”) in a phrase (such as “see ______ in the sky”). If the differences can be easily fixed or there are not likely to be better combinations, then adjustments can be made to accommodate the differences at step 917. For example, the system 100 can spread a syllable over two or more notes or not assign a word to some notes when the number of notes is greater than the number of syllables. The system 100 can split notes to allow for multiple syllables or repeat a verse or chorus an additional time to create more notes when the number of notes is less than the number of syllables.

With this process for generating a musical language learning exercise, a variety of different exercises with different melodies, words, and phrases can be generated. Even further, the exercises can be generated in different languages, or with a mix of languages. For example, as shown in FIG. 9C, the words “bounce, bounce, bounce the ball” can be overlaid with a musical portion, creating a song. Similarly, Mandarin Chinese words saying the same can be overlaid with the same musical portion, as also shown in FIG. 9C. Thus, the exercise can modularly include sections in a user's native language and sections in a user's target language (for example, alternating between native and target languages), or in only the user's target language, all with the same music and the same words (in different languages). Further, the ratio between the languages can be adjusted according to the user's skill level by exchanging words (and the associated audio files) to create different songs. Other phrases can also be used in this manner. For example, with the same music, the system 100 can use the words “eat, eat, eat the rice”, “walk, walk, walk to school”, and “brush and floss your teeth” for just a few examples. As an example, the system 100 can use these techniques to combine at least 10 different music portions with at least 100 words (in each language) into different modular combinations of musical language learning exercises.

It should also be noted that in FIG. 9C, in the Mandarin Chinese version, the word “pí” has a rising tone, and is overlaid with an increase in pitch. Because the rising tone also has an increase in pitch, this makes the word more naturally fit the music with which it is overlaid. In similar embodiments, a departing tone can be overlaid with a decreasing pitch. In the depicted example, the increased pitch is only by two semi-tones, but the audio file for the word might have a greater difference in pitch. Thus, the system 100 can adjust both the initial pitch and the increased pitch of the audio file to match the corresponding pitches in the music portion. Similar techniques can also be used with departing tones. Step 915 of FIG. 9B can optionally be modified to not only check if the numbers of notes and syllables match, but also to check if the pitch profiles of the syllables correspond to the pitch changes in the music. Because it may be very difficult to have full agreement between the pitch profiles of the syllables and pitch changes in the music, the level of agreement can be considered as a factor when deciding at step 916 whether to choose new music or phrases.

FIGS. 9D and 9E show the component music and words combined together to form a bilingual musical language learning exercise. FIG. 9D shows two separate audio files saying the word “ball” in Mandarin Chinese and in English. Each audio file can include data related to the timing of the word, such as a start time in the audio file, an end times in the audio file, a duration of the audio file, a volume-weighted center of the audio file, or other data. When a user records audio files to be used for these purposes by the system 100, this information can be automatically determined by the system by analyzing the sound in the audio file. The data can be used by the system 100 to determine a time of each syllable such that they can be timed to play precisely at the corresponding time with the music to match a corresponding note. In some embodiments, data related to timing in the audio files can be precise to at least a millisecond.

FIG. 9E depicts multiple layers of sound combined to form a bilingual musical language learning exercise. As shown, Music 1 can be a sound track of a melody that can be sung to using words and phrases chosen by the system 100. Music 1 can also optionally provide a harmony and rhythm to accompany the melody. Even further, Music 1 can optionally not include an independent melody, such that the words and phrases adjusted to the appropriate pitch form a melody that musically matches accompanying music (such as harmony or rhythm) in the file Music 1. Music 1 can be overlaid with words and phrases in Language 1 and Language 2, to form a Combined audio output, as shown in FIG. 9E. In the depicted embodiment, words are recited twice in Language 1, and then are followed by the translated word repeated twice in Language 2, with five words taught. These are be provided here in a call-and-response style, with the initial word being recited with a first voice (for example, a single voice meant to emulate an instructor) and the repeated word being recited with a second voice (for example, a group voice meant to emulate a class repeating after the instructor). This voice alternation can encourage a user to participate in the call-and-response activity, with the different voice suggesting that they should join at that point.

### Rhythm

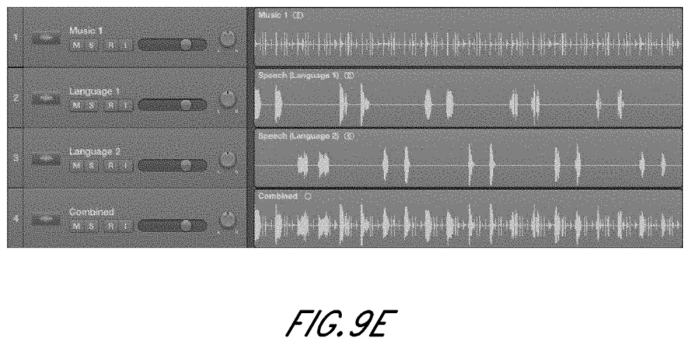

FIG. 10 shows a screenshot of a GUI 1000 for a Rhythm-language acquisition game, titled “Call and Response Keyword Meaning Connect.” The user can hear a vocabulary word or phrase in the target language followed by a cartoon character 1001 playing a rhythm or other visualization and auditory expression of a rhythm on the screen or off-screen. The user then repeats the rhythm on their tap button 1002 or on a smart drum or tapping device synced to the device 109, which serves as a controller for the animation of the object or character 1003 that is visualizing the meaning of the keyword or phrase. This exercise uses rhythm to reinforce the meaning of keywords that can be present in the other exercises described herein. The user physically and mentally engages with the object or character showing the meaning of the word, word-group or phrase 1003, solidifying word-meaning. Through intelligent game or exercise generation described in relation to FIG. 4, the system can customize resources such as rhythmic patterns and vocabulary words and phrases based on the user's skill level and optimized mode of training. For example, a four-year old can only receive rhythmic patterns in quarter and eighth notes with no rests. A more advanced user can be presented with more challenging rhythms and combinations of word groups.

In another embodiment of the exercise, the cartoon character 1001 speaks a vocabulary word, word group, or phrase while concurrently drumming the syllable-rhythm or melody-rhythm of the text. The drumming or speech activates the animation of the object or character 1003 that reflects the word meaning. The user then repeats the word while concurrently drumming, activating the animation of the object 1003.

### Pitch

FIG. 11 shows a screenshot of a GUI 1100 for a Pitch-language game that teaches vocabulary through pitch association. The user learns pitch and language at the same time. In this gamified exercise, the user associates a single vocabulary word 1101 or short phrase and its visualized meaning 1102 with a pitch or pitch pattern, which can be visualized on a piano illustration 1103, staff notation, or graphic representation of pitch height such as a scatter plot. The exercise serves as a combined mnemonic. The user attaches meaning to a vocabulary word through auditory and visual association.

FIG. 12 shows screenshots of Pitch-language game GUIs 1200 and 1201 that teach vocabulary through pitch association. In this case, the exercise teaches Chinese vocabulary. In this gamified exercise, the user alternates Chinese speech-tone contour practice in call and response form (such as in FIGS. 5 and 5A-5E) with pitch patterns from but not limited to patterns from the song in call and response form presented in a musical phrase in order to strengthen the auditory system by practicing music and language together. The user first hears the cartoon character 1202 or system 100 speak a word 1203, word group, or phrase in the target language accompanied by the speech-tone visualization 1204 of that word, word group, or phrase and word meaning visualization 1205. The user repeats the speech-tone, triggering the scooter-tone visualization 1204 processed through voice recognition. In the GUI 1201 the cartoon character 1206 or app then sings a musical pitch or pattern from the song lesson while the song pattern 1207 is visualized on the piano 1208. The piano can have numbers 1209 representing intervals, note names, or solfege symbols that will adapt according to user's educational needs and preference. Through voice recognition, when the user sings, repeating the pitch pattern, the user's voice activates the animation on the piano 1208.

FIG. 13 shows a screenshot of a GUI 1300 displaying a Pitch-language game that uses visual representation of a keyword's meaning 1301 (in this case, “apple”), not limited to but in this case visualizing the apple, and pitch height visualizing a musical scale 1302 to connect word meaning and pitch association within the context of a musical scale. When the word is sung by the cartoon character 1303 or system 100, the corresponding pitch in musical scale 1302 of apples lights up or is animated. The user then repeats the pitch pattern. Through voice recognition processing, the animation is activated by the user's singing.

FIG. 14 shows an example embodiment of a graphical user interface (GUI) displaying a dashboard 1400 of a music-language activity for a learner organized into locations 1402a, 1402b, and 1402c which can serve as modules for zones that contain song lessons. Different locations can appear in different difficulty levels of the game and can be dynamically generated according to user performance. The dashboard 1400 comprises a passport icon 1401 that provides an interface for the user's data and scores as well as access to more activities and exercises, a settings icon 1403, a shopping cart icon 1402 to access a digital store, and a favorites icon 1405 to access a favorites page located in the passport. The dashboard 1400 can include cartoon characters 1406.

FIG. 15 shows an example song selection interface 1501. One or more song lessons can be organized into a zone, visualized in the zone logo 1502. Users can swipe horizontally between different song lesson exercise selection interfaces 1503 within the zone. Exercise selection interface displays Song Lesson Icon 1504 and Song lesson Name 1505. These can or can not be displayed in bilingual or immersion language modes. Exercise selection interface 1503 comprises but is not limited to adaptive story icon 1506, adaptive imitate music-language icon 1507, rhythm game or exercise icon 1508, pitch game or exercise 1509, and puzzle or touch game icon 1510. Icons can be added or deleted depending on the intelligent game generation and game mode created for the user.

### Music Theory-Language Graphs

FIG. 16 shows an example of expected progress for a language acquisition game. The x-axis 1601 shows the level, and the y-axis shows the number of words, word-groups, or phrases mastered at each level.

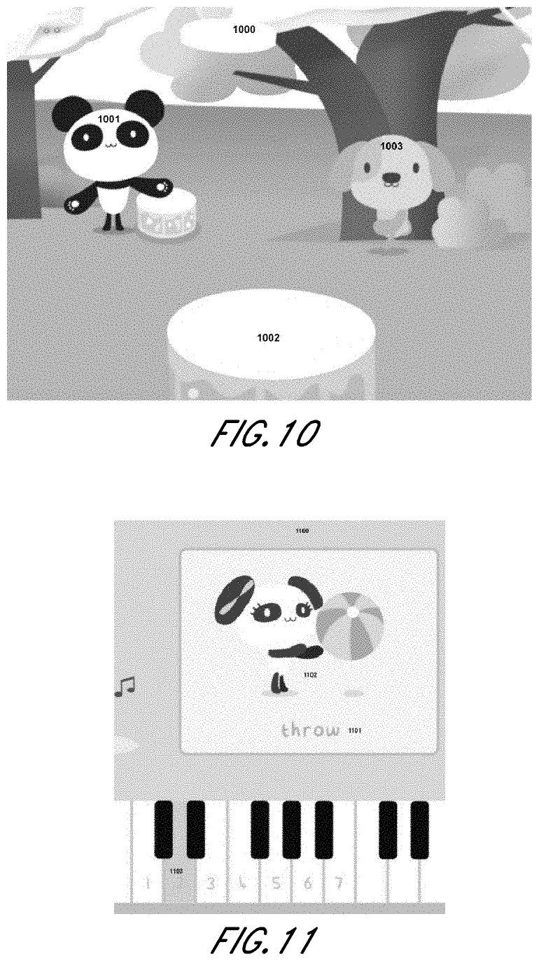

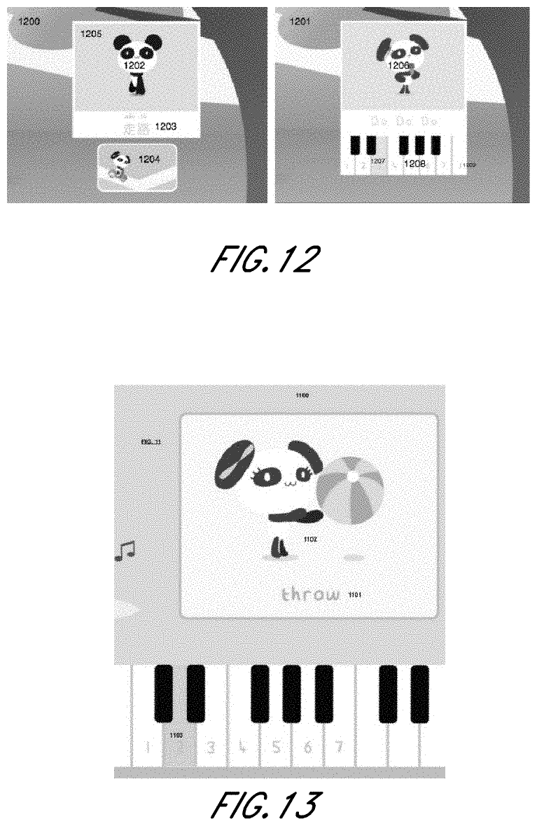

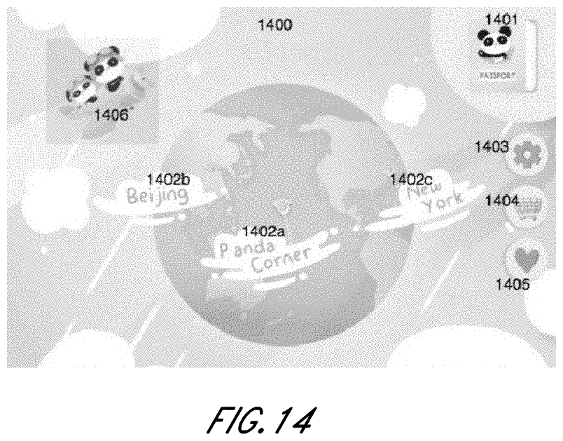

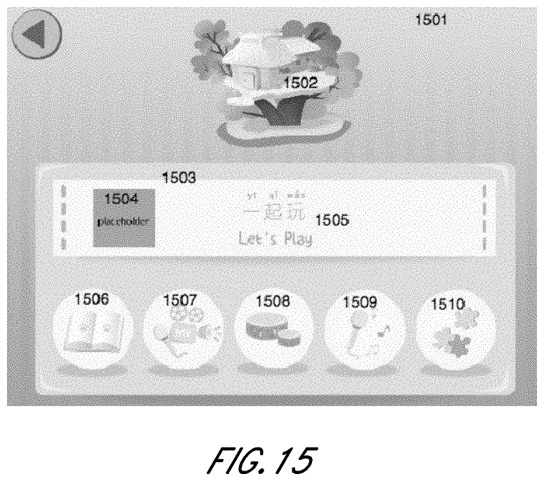

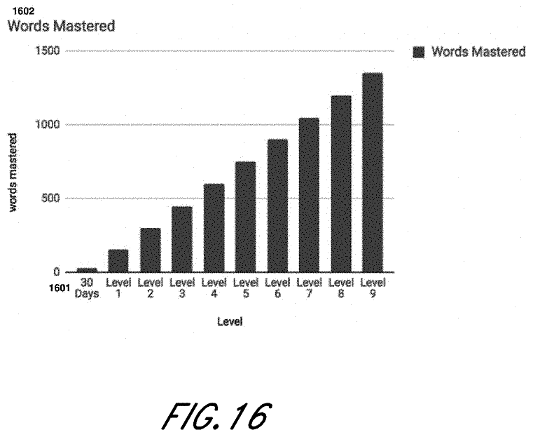

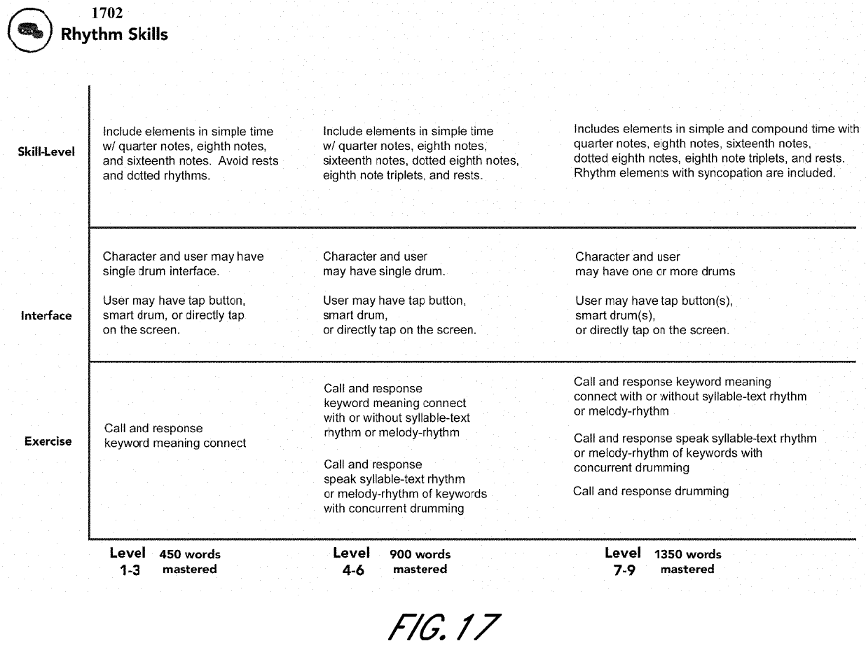

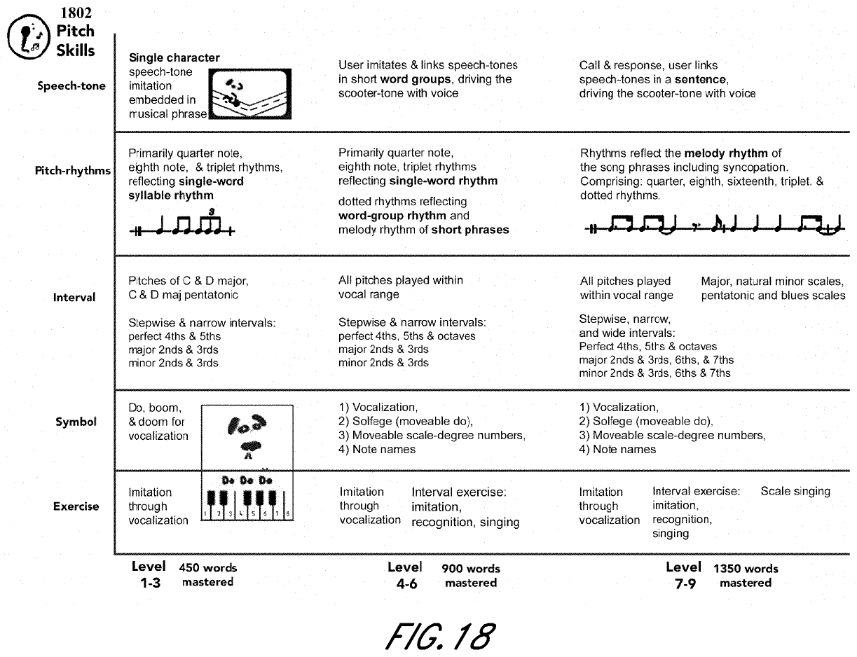

FIG. 17 shows a rhythm skills and language skills graph for one embodiment of a music-language curriculum. The x-axis 1701 shows the number of words and/or phrases taught at each language level. The y-axis 1702 shows the corresponding rhythm skills for the language levels.

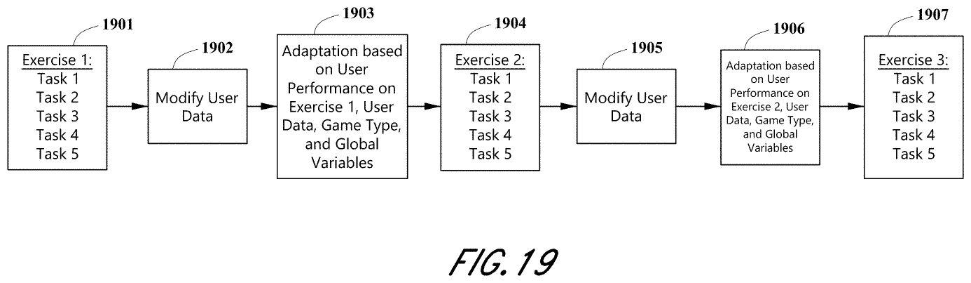

FIG. 18 shows a pitch skills and language skills graph for one embodiment of a music-language curriculum. The x-axis 1801 shows the number of words and/or phrases taught at each language level. The y-axis 1802 shows the corresponding pitch skills for the language levels.

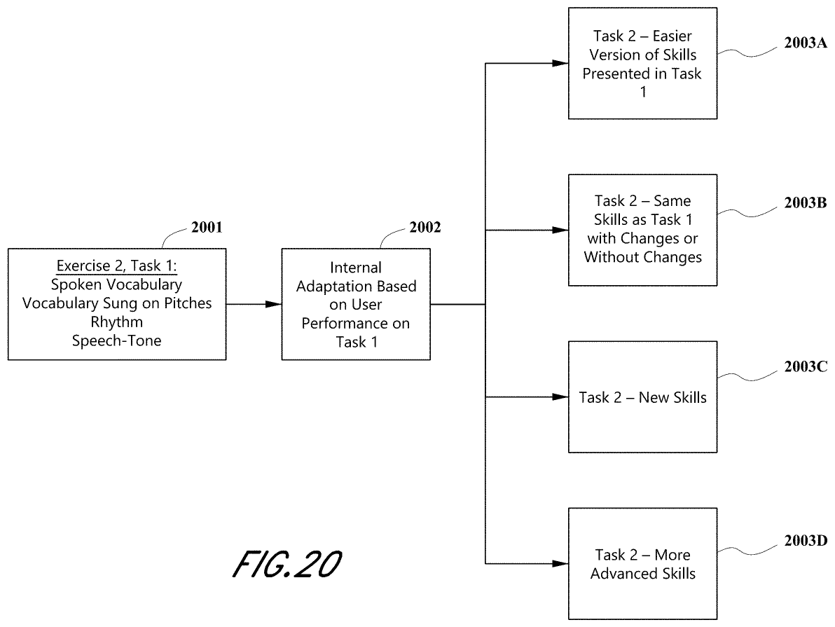

FIG. 19 shows a process for Real Time and Periodic Adaptation before, during, and after an exercise. In step 1901, the user engages in Exercise 1 which comprises but is not limited to Tasks 1-5 that present language and music skill such as vocabulary, rhythm, and pitch skills. In step 1902, the system modifies user data based on the user's performance. In step 1903, the system takes several inputs comprising but not limited to user performance on Exercise 1, User data, Game type, and Global variables to generate Exercise 2 1904 that is customized according to the user's skill-level and preferences. The user then partakes in Exercise 2 in step 1904 that is further personalized through Internal Exercise Adaptation (see FIG. 20). In Adaptation step 1905 the system modifies user data. In step Adaptation 1906 inputs comprising but not limited to User performance on Exercise 2, User Data, Game type, and Global Variables generate a customized Exercise 3 presented in 1907.

In one embodiment, the performance of a skill is represented as an array. The difficulty level at which the skill was performed is part of the array. The User Data for the performance of that skill is represented as a matrix. The matrix for the skill is evaluated against a set of threshold comparisons which can include comparing it to other arrays or matrices. The threshold comparison can involve converting the skill performance matrix to a new matrix (which can be a single value) prior to making the threshold comparison. Partially based on the threshold comparison, the system determines the next Exercise for the user.

FIG. 20 shows internal exercise adaptation. Exercise 2 refers to 1904 in FIG. 19. In step 2001, the user partakes in Exercise 2, Task 1 which can include skills comprising but not limited to spoken vocabulary, vocabulary sung on pitches, rhythm, and speech-tone. In one embodiment, the user can excel at vocabulary, but have difficulty singing the vocabulary on the correct pitches in tune. In this case, in step 2002, the system takes into account user performance on Task 1 and generates a customized, educationally appropriate Task 2. For example, in the case when the user has difficulty with pitch in step 2003B, the user can receive Task 2, that can be a modified version of Task 1 at a slower tempo focusing on pitch skills. Alternatively, the user can be presented with an easier version of the skills in Task 1, new skills, or more advanced skills.

Many other variations on the methods and systems described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various algorithm steps described in connection with the embodiments disclosed herein can be implemented as electronic hardware, computer software, or combinations of both. To clearly illustrate this interchangeability of hardware and software, various illustrative steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative steps, components, and computing systems (such as devices, databases, interfaces, and engines) described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor can also include primarily analog components. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm, and database used in said steps, described in connection with the embodiments disclosed herein can be embodied directly in hardware, in a software module executed by a processor, or in a combination of the two. A software module, engine, and associated databases can reside in memory resources such as in RAM memory, flash memory, ROM memory, EPROM memory, EEPROM memory, registers, hard disk, a removable disk, a CD-ROM, or any other form of non-transitory computer-readable storage medium, computer program product, media, or physical computer storage known in the art. An example storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

1. A computer implemented method for generating audio language learning exercises, the method comprising:
determining a user native language, a user target language, and a user skill level in the target language;
automatically generating a musical language learning exercise comprising words in both the user native language and the user target language, according to at least the user skill level; and
playing the musical language learning exercise to the user.

2. The computer implemented method of claim 1, wherein automatically generating a musical language learning exercise comprises overlaying a plurality of pre-recorded words in the user target language and native language and a music portion such that the words melodically integrate with the music portion.

3. The computer implemented method of claim 2, wherein a plurality of the pre-recorded words comprise two or more pre-recorded individual syllables.

4. The computer implemented method of claim 2, further comprising the step of recording a plurality of words said by a user, and using the recordings as at least part of the pre-recorded words.

5. The computer implemented method of claim 4, further comprising the step of determining a time of at least a first syllable of the recorded plurality of words said by the user in the recordings.

6. The computer implemented method of claim 2, wherein the pre-recorded words are stored in audio files such that a time of the first syllable of the word in an audio file is known.

7. The computer implemented method of claim 6, wherein overlaying a plurality of pre-recorded words comprises overlaying the words such that the first syllable of the words are contemporaneous with notes in the music portion.

8. The computer implemented method of claim 7, wherein the plurality of pre-recorded words comprises at least one word comprising more than one syllable, and wherein overlaying a plurality of pre-recorded words comprises overlaying the at least one word comprising more than one syllable such that the first two syllables are contemporaneous with notes in the music portion.

9. The computer implemented method of claim 8, further comprising adjusting an audio file of the at least one word comprising more than one syllable to adjust a duration of the word such that the first two syllables are contemporaneous with notes in the music portion.

10. The computer implemented method of claim 9, further comprising adjusting a pitch of the audio file of the at least one word comprising more than one syllable to match a note's pitch in the musical sound track.

11. The computer implemented method of claim 2, wherein overlaying a plurality of pre-recorded words comprises choosing a pre-recorded word to be overlaid with the music portion at a location in the music portion such that a pitch tone pattern of a pre-recorded word matches the change in pitch at the location in the music portion.

12. The computer implemented method of claim 11, wherein a pre-recorded word comprising a rising tone is overlaid with an increasing pitch in the music portion.

13. The computer implemented method of claim 12, further comprising adjusting a pitch of the audio file of the word comprising a rising tone such that both an initial pitch and an increased pitch match corresponding pitches in the music portion.

14. The computer implemented method of claim 11, wherein a pre-recorded word comprising a departing tone is overlaid with a decreasing pitch in the music portion.

15. The computer implemented method of claim 14, further comprising adjusting a pitch of the audio file of the word comprising a departing tone such that both an initial pitch and a decreased pitch match corresponding pitches in the music portion.

16-29. (canceled)

30. A non-transitory computer-readable medium storing instructions that, when executed by one or more processors of a computing system, cause the computing system to:
determine a user native language, a user target language, and a user skill level;
automatically generate a musical language learning exercise comprising words in both the user native language and the user target language, according to at least the user skill level; and
play the musical language learning exercise to the user.

31. The non-transitory computer-readable medium of claim 30, wherein the instructions further cause the computing system to overlay a plurality of pre-recorded words in the user target language and native language and a music portion such that the words melodically integrate with the music portion.

32.-39. (canceled)

40. The non-transitory computer-readable medium of claim 30, wherein the instructions further cause the computing system to choose a pre-recorded word to be overlaid with the music portion at a location in the music portion such that a pitch tone pattern of a pre-recorded word matches the change in pitch at the location in the music portion.

41.-58. (canceled)

59. A system comprising one or more processors and non-transitory computer storage media storing instructions that when executed by the one or more processors, cause the one or more processors to perform operations comprising:
determine a user native language, a user target language, and a user skill level;
automatically generate a musical language learning exercise comprising words in both the user native language and the user target language, according to at least the user skill level; and
play the musical language learning exercise to the user.

60. The system of claim 59, wherein overlaying a plurality of pre-recorded words comprises selecting a pre-recorded word to be overlaid with the music portion at a location in the music portion such that a pitch tone pattern of a pre-recorded word matches the change in pitch at the location in the music portion.
